(19) United States
(12) Patent Application Publication
(10) Pub. No.: US 2005/0155211 A1
(43) Pub. Date: Jul. 21, 2005

(54) Magnetic bolt holder

(76) Inventor: David Edward Powell, Nolensville, TN (US)

Correspondence Address: David E. Powell, 1808 Burke Hollow Road, Nolensville, TN, 37135, US

(21) Appl. No.: 10/759,700

(22) Filed: Jan. 20, 2004

(51) Int. Cl. B25B 9/00; B25C 3/00

(52) U.S. Cl. 29/467; 29/464; 29/465; 81/13; 81/44; 81/55

(57) ABSTRACT

A tool is provided for holding a bolt in a hole on a ferrous structure, preventing it from rotating or exiting the hole when the nut is attached to or removed from it on the opposite side of the structure. This tool may also be used to hold a threaded nut over said hole, while the threaded part of the bolt is inserted through the hole from the opposite side of the structure and instilled into or withdrawn from the nut. The tool consists of a metal disk or plate with one or more attached permanent magnets and possessing an indentation or recess of a size and shape that will mate with the portion of the fastener being held (e.g., the head of a bolt or its nut), thereby preventing rotation and movement of that part of the fastener while its mating part is attached or removed from the opposite side of the structure.

### CROSS-REFERENCE TO RELATED APPLICATIONS

U.S. Patent Documents

| | | | |
|---|---|---|---|
| 5,954,466 | Sep. 21, 1999 | Coffey, et al. | 411/119 |
| 6,588,303 | Jul. 8, 2003 | Walsh; Leonard M. | 81/13 |
| 6,666,116 | Dec. 23, 2003 | Marks; Charles C. | 81/462; 81/13 |

### STATEMENT REGARDING FEDERALLY SPONSORED RESEARCH OR DEVELOPMENT

Research and development for this invention was not federally sponsored.

### REFERENCE TO SEQUENCE LISTING, A TABLE, OR A COMPUTER PROGRAM LISTING COMPACT DISK APPENDIX

Not applicable.

### BACKGROUND OF THE INVENTION

This invention is a device which will hold part of a threaded fastener in position while the other part is mated to the part being held. This is especially useful in situations where it is difficult or impossible to access both parts of the fastener simultaneously.

In fastening operations utilizing a threaded fastener assembly such as a bolt and nut, the bolt portion of the fastener assembly often is inserted into a hole in a structure, such as the wall of a metal building, and is held there while the nut is attached to the other end. A subtle but important alternative is to hold the nut aligned with the hole while the bolt is inserted through the hole and rotated to attach it to the nut. This is a simple and easy two-handed operation under most circumstances, but can be almost impossible to do in others. This is especially difficult to accomplish when the structure through which the bolt passes prevents the user from holding the bolt during the fastening process, and the hole through which the bolt passes is somewhat oversize. In these cases, any small amount of pressure applied to the bolt while attempting to engage the nut will cause it to fall from the hole. Attempting to use the alternative method mentioned above (i.e., expecting the nut to remain aligned over the hole without assistance while the bolt is inserted) would be downright silly. Heretofore, operations such as this would require the services of two people, one to hold or insert and rotate the bolt and another on the opposite side of the structure to hold or attach the nut.

What is needed then, is a device to hold the bolt in the hole (or the nut aligned with the hole) without human assistance, thereby freeing the user and allowing him or her to relocate to the opposite side of the structure and attach the nut or insert the bolt. There are tools available to perform this function, however, they depend on the presence of another, similar fastener or other object located in close proximity to the one being attached. Reference U.S. Pat. No. 6,666,116 or U.S. Pat. No. 6,588,303 for examples.

### BRIEF SUMMARY OF THE INVENTION

The invention described herein is designed to hold a bolt in a hole (or a nut aligned with a hole) without human assistance, thereby freeing the user and allowing him or her to relocate to the opposite side of the structure and attach the mating nut or insert the mating bolt, when the structure to which the bolt is being attached is made of a ferrous material such as iron or steel. It is a simple device comprised of a small metal plate to which one or more strong magnets have been permanently mounted, and has a centrally located recess which is the proper size and shape to hold either the head of the bolt or the nut. A hole which is approximately 95 percent as large as the recess is located in the center of the recess. A convenient handle sized to fit a typical human index finger is provided to aid in the removal of the device from the structure after use.

To use the device, the user may choose between two scenarios. In the first scenario, the bolt is inserted into the hole in the metal structure, and the device is placed over the head of the bolt, the head being in the aforementioned recess in the device, where it is held magnetically to the metal structure. The user then relocates to the opposite side of the metal structure and attaches the nut to the bolt. By virtue of the magnetic coupling between the device and the metal structure, the bolt is held in place while the nut is attached. Additionally, by virtue of the size and shape of the recess in the device and the friction that exists between the magnet(s) and the structure, the nut may be tightened by conventional means while the device prevents the bolt from rotating.

In the second scenario, the nut is placed into the recess of the device, and then the device is placed over the hole in the metal structure, where it is held in place by the magnetic attraction between the device and the structure. The hole in the center of the recess is useful for visually aligning the nut with the hole in the structure. The user then relocates to the opposite side of the structure and inserts the bolt through the hole and into the nut. Again, by virtue of the size and shape of the recess in the device and the friction that exists between the magnet(s) and the structure, the bolt may be tightened by conventional means while the device prevents the nut from rotating on the opposite side of the structure. Any excess bolt length will pass through the hole in the center of the recess of the device.

Both of these scenarios may be procedurally reversed if the operation involves removing the fastener instead of installing it.

An inherent feature of this device is that it need not be carefully positioned over the head of the bolt when applied, as any minor misalignment will be automatically corrected when the bolt is rotated from the opposite end.

### Brief Description of the Several Views of the Drawing

FIG. 1 is a top view of the invention. The attached magnet is not visible from this angle.

FIG. 2 is a side view of the invention, as if FIG. 1 were rotated 90 degrees to the right along the vertical axis. The magnet likewise is hidden from view in this drawing.

FIG. 3 is a perspective view showing the bottom of the invention, as if FIG. 1 were rotated 120 degrees to the left along the vertical axis. This is the only drawing which shows the magnet portion of the invention. The handle is not visible in this drawing.

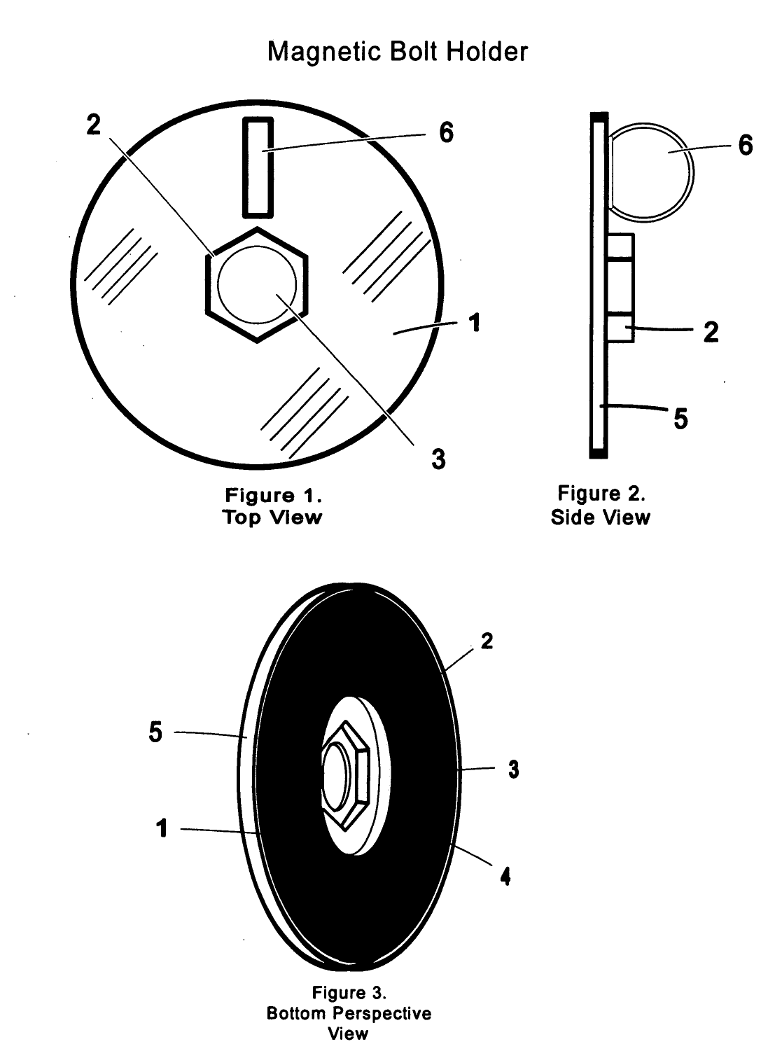

### DETAILED DESCRIPTION OF THE INVENTION

The text in this section refers to the drawing, wherein like numerals represent like elements throughout the several views of the present invention. It is anticipated that a multitude of the present invention will be manufactured, combined, and offered as a set, each being identical to the other except for the size and/or shape of recess 2, and therefore specific information pertaining to the exact size and shape of recess 2 is not given.

The primary body 1 of the invention consists of a 2.5 inch diameter circular disc of 21-gauge flat steel, which has been stamped or otherwise formed to produce ⅛-inch lip 5 around the edge. Likewise, a recess 2 is formed in the center of the disc, protruding in the opposite direction from lip 5. The size and shape of said recess 2 is such that the particular bolt or nut for which it is made will fit loosely inside of it without binding, but will not allow the bolt or nut to rotate therein. A small circular finger handle 6 is attached close to the perimeter of primary body 1 to aid in the removal of the device after use.

Hole 3 is centrally located in recess 2 and is large enough for the threaded portion of the particular bolt for which it is made to easily pass through, but not large enough for the head of said bolt, nor its mated nut, to pass through.

Magnet 4 is a ⅛-inch thick circular permanent magnet, 2.4 inches in diameter with a 1-inch diameter hole in the center. Magnet 4 is mounted in body 1 with a suitable adhesive in such a manner that lip 5 around the circumference of body 1 protects the edge of magnet 4 from damage.

While the preferred embodiment of this invention has been described herein, there are other embodiments that will work equally well and are apparent to be within the scope of my invention.

1. A method for magnetically holding, without human support beyond initial placement, one part of a two-part threaded fastener while the fastener is being installed on or removed from a ferrous structure, by utilizing a device consisting of a metal disk or plate with one or more attached permanent magnets and possessing an indentation or recess of a size and shape that will mate with the portion of the fastener to be held (for example, the head of a bolt or its nut), for the purpose of preventing rotation and movement of that part of the fastener while the mating part of the fastener is attached thereon.

2. A kit or set consisting of a plurality of devices as described in claim 1, each of which is identical to the others with the exception of the size and/or shape of the recess, for the purpose of having usefulness across a wide range of fastener sizes and/or types.
